(19) United States
(12) Patent Application Publication
(10) Pub. No.: US 2016/0359351 A1
(43) Pub. Date: Dec. 8, 2016

(54) Retractable, Rechargeable Extending-coil Electric Lighter

(71) Applicant: Matthew Stoll, San Mateo, CA (US)

(72) Inventor: Matthew Stoll, San Mateo, CA (US)

(21) Appl. No.: 15/174,998

(22) Filed: Jun. 6, 2016

Related U.S. Application Data
(60) Provisional application No. 62/170,759, filed on Jun. 4, 2015.

(51) Int. Cl. H02J 7/00; F23Q 7/02; F23Q 7/16

(52) U.S. Cl. CPC H02J 7/0045; H02J 7/0047; H02J 7/0052; F23Q 7/16; F23Q 7/02; H02J 2007/005; H02J 2007/0062

(57) ABSTRACT

An electric, rechargeable and retractable lighter is disclosed. The lighter is specially equipped with an extending heating element configured to competently and expediently light tobacco, cannabis, or other packed bowls from pipes and water-pipes. The electric lighter includes a casing having a top portion and a bottom portion, and containing at least one rechargeable battery and a circuit board. The circuit board is in communication with an electric heating element configured to extend out from within the casing, and down into the bowl of the pipe. The distal end of the casing is equipped with a retractable male USB connection to charge the battery from any female USB port. A bi-directional sliding switch mechanism is disposed within the casing to facilitate activation of the electric heating element, the extension of the electric heating element, and/or the extension of the male USB connection for charging.

### CONTINUITY

This application is a non-provisional application of provisional patent application No. 62/170,759, filed on Jun. 4, 2015, and priority is claimed thereto.

### FIELD OF THE PRESENT INVENTION

The field of the present invention relates to incendiary devices and heat ignition devices, and more specifically relates to devices configured to light aflame smoking materials including cannabis, tobacco, and other herbal smoking plant matter.

### BACKGROUND OF THE PRESENT INVENTION

A wide variety of lighters are available on the market today that cater to a wide variety of tastes. A large assortment of lighting mechanisms, shapes, colors, and sizes of lighters or incendiary devices are marketed to consumers as an ideal smoking tool and apparatus. Unfortunately, nearly all of the incendiary devices available on the market today are configured to cast a flame or heat from a unidirectional, static point, or are fashioned to limit the user's control of the flame. Therefore, the majority of lighters sold are standard, disposable lighters designed to be thrown away after the fuel is used. The excessive amount of disposed lighters has a detrimental effect on the environment, as disposable lighters are rarely recycled.

Some smokers prefer to use pipes or water pipes which are commonly composed of glass, wood, clay, and other conventional solid materials. Per convention, pipes are generally equipped with a recessed bowl that is pressed into the glass during blowing, or is incorporated into a slide mechanism for water-pipes. The bowl is packed with smoking material to be ignited with an incendiary device and smoked. If an analog lighter is employed to light the smoking material, the open flame is conventionally pulled toward the smoking material as the user inhales through the pipe. For this reason, traditional open-flame lighters are usually employed. While some open-flame lighters are refillable, the majority of lighters used are disposable. As such, the majority of lighters are thrown away, adding to landfills to await eventual decay.

Electric lighters are conventionally equipped with a coiled low resistance wire, which when supplied with a current, become heated to light cigarettes and cigars for smoking conventionally. Presently, there is no electric, coil-based lighter on the market capable of effectively lighting the bowl of a pipe, as the pipe bowl is recessed, and therefore inaccessible to the exposed heated coil of conventional electric lighters.

Thus, there is a need for a new coil-based electric lighter equipped with an extendable coil section so as to effectively extend down within a pipe or water-pipe bowl to easily light aflame the smoking material contained within the bowl. Such a device is preferably rechargeable via a conventional USB male plug configured to retract and extend from the body of the electric lighter, so as to maximize the life of the electric lighter, and to minimize the disposal of conventional lighters, reducing the carbon footprint of the user.

### SUMMARY OF THE PRESENT INVENTION

The present invention is a versatile, rechargeable, retractable-coil electric lighter. The present invention is equipped with a bi-directional multi-function sliding switch. The switch is preferably equipped with three positions, a center neutral/off position, an ‘ON’ position, and a charge position. The charge position is displaced such that it is diametrically opposite from the ‘ON’ position, as shown in FIG. 2. When the switch is manually moved to the on position, the movement of the switch activates the heating mechanism of the electric coil.

The present invention is preferably housed in a casing preferably constructed of metal, polycarbonate, plastics, or acrylics. Additionally, the casing is equipped with a top portion and a bottom portion that includes an integrated battery holder, battery, and circuit board disposed between the top portion and the bottom portion. The battery holder and battery are in communication with at least one circuit board configured to regulate and control the electric heating element. The electric heating element is preferably equipped with a ceramic insulation ring jacket disposed around the electric heating element. The electric heating element is exposed by the openings of a top cap configured to fixedly bind the top portion to the bottom portion of the casing of the present invention during manufacturing. A USB male connector is configured to extend out from within the casing when needed to charge the battery of the present invention. The ignition control switch is in communication with the switch and circuit board. An LED light is configured to illuminate when power is supplied to the electric heating element via the circuit board connector. The casing preferably has a hollow body that is open on one side, and the ignition control switch is exposed by a lateral hole within the casing. A series of preferably four LED bulbs disposed below the switch are configured to illuminate to indicate the present battery-strength status to the user.

When the switch is in the ‘ON’ position, the ignition control circuit activates the electric heating element warming the coil, and the LED lights are illuminated. The cross section of the casing is preferably of a polygonal circular, elliptical or other shape. The preferred embodiment of the present invention preferably employs the use of stainless steel as a connector for the charging interface via the male USB charging connection. The battery of the present invention is preferably a rechargeable lithium battery.

The result of the apparatus of the present invention is an effective lighter device that is practical, low in cost to manufacture, easy to use, employs flameless ignition for safety, and provides a long service life.

### BRIEF DESCRIPTION OF THE DRAWINGS

The present invention will be better understood with reference to the appended drawing sheets, wherein:

FIG. 1 displays a view of the side of the preferred embodiment of the present invention as seen from the top, detailing the profile of the present invention.

FIG. 2 exhibits a view of the present invention as seen from the top, detailing the electric coil of the present invention.

FIG. 3 shows the trap doors of the present invention.

### DETAILED DESCRIPTION OF THE PREFERRED EMBODIMENT

The present invention is an electronic lighter for pipes, water-pipes, cigarettes, and cigars. The present invention generally comprises a casing (10), a bi-directional sliding switch mechanism (20), an electric heating element (30), and a power source (40). The bi-directional sliding switch mechanism (20) preferably has three switch positions: an ‘on’ position (45) wherein the bi-directional sliding switch mechanism (20) is pushed forward/upward to an ‘on’ position, extending the electric heating element (30) from the casing (10) and activating the electric heating element (30), a neutral center position (35), and a charging position (55). The casing (10) is preferably equipped with a top portion (15) and a bottom portion (25). At least one battery (80) is disposed within the casing (10) in a battery holder (30) preferably integrated into the bottom portion (25) of the casing (10).

A circuit board (40), similarly housed within the casing (10) is configured to regulate the power from the at least one battery (80). An LED battery-strength indicator (50) is in communication with the circuit board (40) and the at least one battery (80), and facilitates a quick visualization of remaining battery life that is expressed with LED lights (90) configured to illuminate completely when the at least one battery (80) is fully charged. A weaker battery is expressed with the LED lights (90) by denoting that only three, two, or one of the preferably four LED lights (90) of the LED battery strength indicator (50) are illuminated.

Additionally, the preferred embodiment of the present invention is equipped with a male USB connector (100) configured to facilitate recharging of the at least one battery (80) of the present invention by the user.

The casing (10) of the present invention is preferably fitted with an opening cap (110) disposed at the top of the present invention, circumscribing the electric heating element (30) of the present invention.

The circuit board (40) is in communication with the element heating element (30), and functions to regulate and relay power from the at least one battery (80) to the electric heating element (30) when the bi-directional sliding switch mechanism (20) is pushed to the ‘on’ position (25).

The electric heating element (30) is preferably equipped with a ceramic insulation jacket ring (120) to minimize the transfer of heat from the electric heating element (30) to the casing (10). The electric heating element (30) of the present invention preferably consists of a coiled, low resistance wire in communication with the circuit board (40) and at least one battery (80).

A ceramic insulation ring (120) is disposed around the electric heating element (30) to keep the top cap (80) cool, as it is envisioned that the electric heating element (30) is configured to generate heat reaching 300˜600° C. to adequately and successfully light a pipe bowl. The heat generated via the present invention does not produce and open flame, making the present invention safer to use than conventional open-flame lighters.

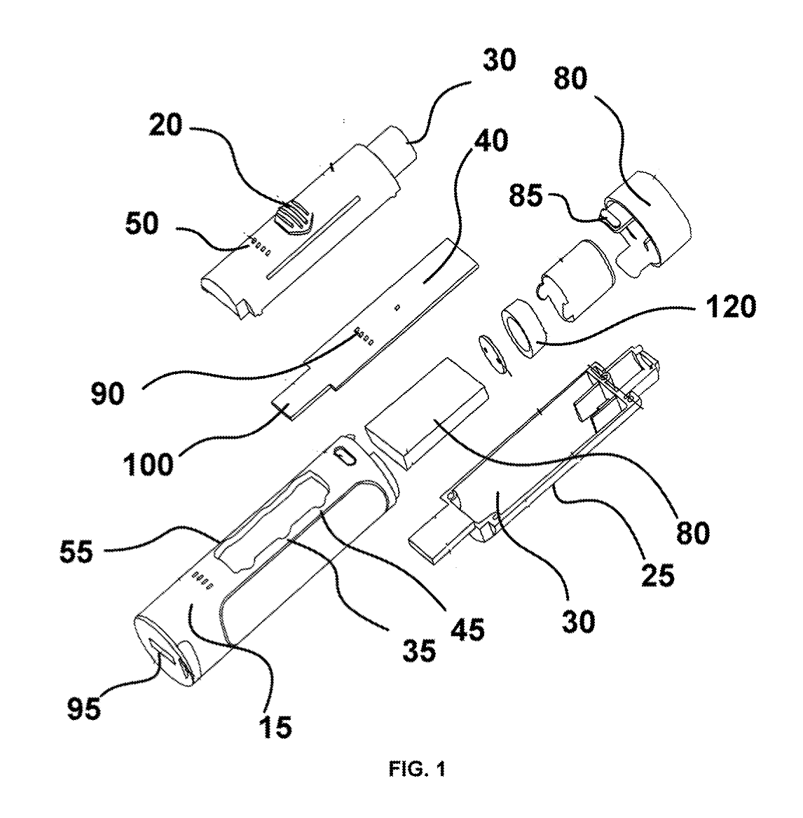

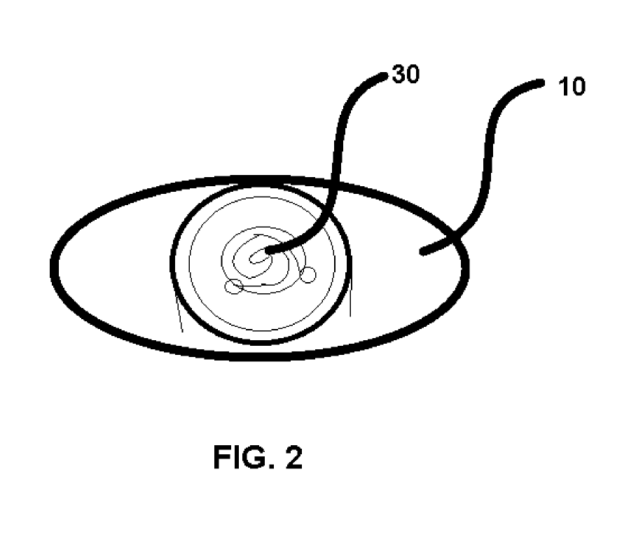

The top side (130) of the casing (10) a fixed top cap (80) is disposed atop the top side of the casing (10), and is preferably equipped with a top opening (85), as seen in FIG. 2 to permit and facilitate the extension of the electric heating element (30) during use. A bottom opening (95), shown in FIG. 1, permits the extension of the male USB connector (100) (At least one fixing hole (60) is disposed on both the top portion (15) and bottom portion (25) of the casing (10), and is configured to accept at least one elastic prong (85) to fixedly mount the top cap (80) in position, securing the top portion (15) and the bottom portion (25) of the casing (10) together. The top cap (80) is held removably in place via plastic elastic inserts (100).

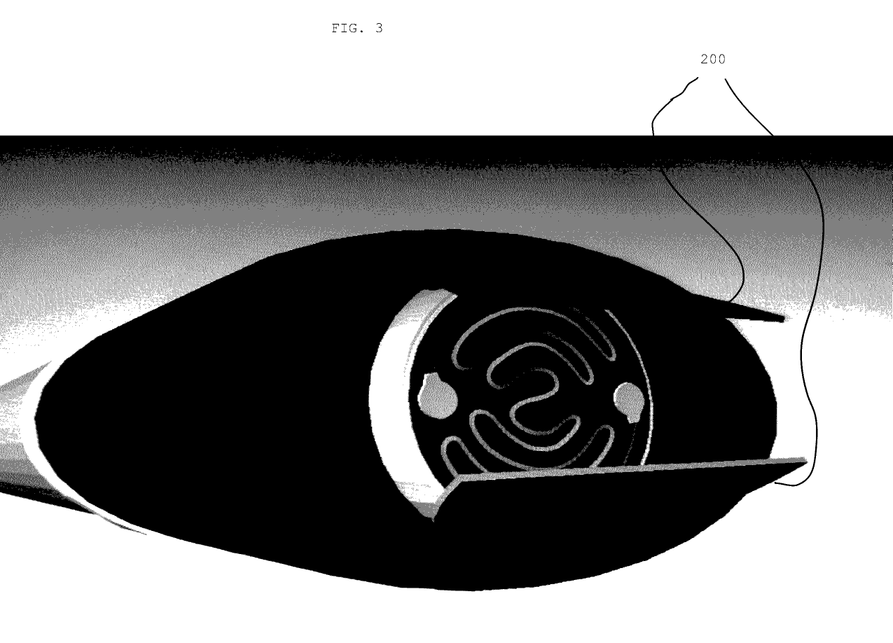

Additionally, it is envisioned that some embodiments of the present invention are equipped with a child-safety lock feature. The child-safety lock feature of the present invention helps to prevent unwanted use of the lighter, and to prevent possible harm to children. The child-safety lock feature preferably functions to lock the electric heating element (30) so it may not fire and cause injury. As such, the center portion of the bi-directional sliding switch mechanism (20) is preferably equipped to function as a locking button, wherein the bi-directional sliding switch mechanism (20) must be pressed inward or upward three times in succession in order to unlock the present invention for use. Similarly, the process is repeated to lock the device. Some embodiments may feature variations on the number of times the bi-directional sliding switch mechanism (20) must be pressed in order to lock/unlock the present invention for safe use. As shown in FIG. 3, trap doors (200) are shown that open when the electric heating element (30) is extended from the casing (10) because the electric heating element (30) pushes trap doors (200) open. Trap doors (200) are preferably conventionally spring-loaded such that when the electric heating element (30) is retracted into the casing (10), trap doors (200) closed.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. An electric lighter comprising:
a casing;
a bi-directional sliding switch mechanism, said bi-directional sliding switch mechanism disposed on an outside of said casing;
a power source, said power source disposed within said casing;
a circuit board, said circuit board in communication with said power source;
an electric heating element, said electric heating element in communication with said circuit board and said power source;
a male USB connector, said male USB connector is in communication with said circuit board;
wherein said bi-directional sliding switch mechanism is configured to unsheathe said electric heating element from said casing and activate said electric heating element upon sliding upwards;
wherein said bi-directional sliding switch mechanism is configured to unsheathe said male USB connector from within said casing upon sliding downwards; and
wherein said power source is configured to be recharged via said male USB connector.

2. The apparatus of claim 1, wherein said power source is at least one rechargeable battery;

3. The apparatus of claim 2, further comprising:
at least one LED light; and
wherein said at least one LED light is configured to illuminate to indicate strength of said at least one rechargeable battery.
